(19) United States
(12) Patent Application Publication
(10) Pub. No.: US 2007/0172301 A1
(43) Pub. Date: Jul. 26, 2007

(54) Mechanism for writing instrument and writing instrument comprising same

(76) Inventors: Franck Rolion, Belloy En France (FR); Hugues Hannequin, Lesigny (FR); Anthony M. Wlodarczyk, Yucaipa, CA (US)

Correspondence Address: JONES DAY, 222 EAST 41ST ST, NEW YORK, NY, 10017, US

(21) Appl. No.: 10/598,277

(22) PCT Filed: Feb. 22, 2005
(86) PCT No.: PCT/FR05/00411

§ 371 Date: Aug. 23, 2006

(30) Foreign Application Priority Data
Feb. 24, 2004 (FR) 0401842

(51) Int. Cl. B43K 7/12; B43K 5/16

(52) U.S. Cl. 401/117; 401/116

(57) ABSTRACT

A mechanism for writing instruments that includes a first element, which includes a guide extending between substantially parallel first and second edges and a second element, which includes a pin extending into the guide and is movable along the guide, where the pin has a given width along the transverse direction of the guide; and at least one locking device for the pin. The locking device includes a recess extending in the first edge between a first and a second end and an elastic member which extends opposite the recess from at least one first base integral with the first end of the recess.

This application is a national stage application of PCTFR2005/000411, filed on Feb. 22, 2005.

### FIELD OF INVENTION

The embodiments of the present invention relate to a mechanism intended, in particular, for a writing instrument.

### BACKGROUND OF INVENTION

More specifically the embodiments of the present invention relate to a mechanism including:
a first element comprising a guide extending between substantially parallel first and second edges;
a second element comprising a pin extending into the guide and movable along the guide, the pin having a given width along the transverse direction of the guide; and
at least one locking device for the pin.

Many writing instruments include such a mechanism for extending and retracting a writing point. which is most often a ballpoint. In these mechanisms, the guide, which is also called a cam channel, is made in the shape of a groove or slit.

The guide may be helical, as described in document FR A 2 809 671, in order to convert a pivoting movement of one of the parts of the body into a translational movement of the point along the longitudinal axis of the instrument.

To lock the writing point into an extended and/or retracted position, it is known to form an elbow or notch into which the pin from the second element of the mechanism engages. However, the pin can generally come out of the housing fairly easily. for example when the pen is dropped a short distance or when one presses too hard on the point. These mechanisms can also give a disagreeable sensation of play because of the freedom of movement of the pin in the housing. To reduce this sensation of play, it is known to keep the pin pressed to the bottom of the housing through the pressure exerted by a spring on the second element. However, the use of a spring increases the force to be exerted to reach a locked position. Further, in this case the force necessary to lock the writing point in extended position is generally greater than that necessary to lock the point in s retracted position.

In other types of writing instruments, the guide generally extends along the longitudinal direction, the mechanism then being controlled by a pushbutton.

For the latter mechanisms, the guide may terminate in a heart-shaped channel in which the pin is trapped between two actions exerted on the button. But, in addition to the disadvantages mentioned in the case of the helical guide mechanisms, the locking or unlocking of the mechanism cannot always be obtained for each action exerted on the button.

Together these disadvantages have a deleterious influence on the overall comfort of using the writing instrument.

### SUMMARY OF INVENTION

The object of the embodiments of the present invention is to mitigate the disadvantages mentioned above, by proposing a mechanism which can be locked and unlocked in at least one position securely and comfortably without, if possible, increasing the manufacturing cost.

For this purpose, one subject of the embodiments of the present invention is a mechanism of the aforementioned type, characterized in that the locking device includes a recess extending in the first edge of the guide between a first and a second end, and an elastic member which extends opposite the recess from at least one first base integral with the first end of the recess, to a summit placed in the guide at a distance from the second edge which is less than the width of the pin, the elastic member being susceptible to be pushed back towards the recess during passage of the pin.

The force necessary for positioning the pin of the second element from one side of the locking device to the other depends on the elastic member's restoring force and on its profile. Consequently, once the geometry of this member is determined, the locking force is constant whether the locking device is used for the extended or retracted position of the point, and similarly for pens having noticeably different geometries.

The recess allows withdrawal of the elastic member during passage of the pin, and consequently the width of this pin can be very close to the width of the guide, which limits the play and improves comfort.

In preferred embodiments of the present invention, recourse is additionally made to one and/or another of the following arrangements:
the base of the elastic member extends into the extension of the first edge in order to reduce the possibility of play of the pin in the area of the locking device;
the elastic member has a second base integral with the second end of the recess for avoiding catching of the pin whatever its direction of movement;
the elastic member has an intermediate U-shaped portion, the ends of the U-shaped branches being respectively integral with the first and second bases, and the summit of the elastic member being formed by the base of the U;
the first base has a length substantially different from the length of the second base so that the unlocking force might be different from the locking force;
the guide has at least one end stop extending between the first and second edges, the locking device being arranged at a distance from the stop which is suitable for the elastic member to be in contact with the pin when it is pressed against the end stop in order to immobilize the pin between it and the elastic member; and
the first element and the locking device are formed from a single plastic part obtained by molding, in order to reduce manufacturing costs.

The embodiments of the present invention also relate to a writing instrument including a tubular body having a front end provided with an opening, a writing point that can move between a storage position in which the point is arranged inside the body and a writing position in which the point passes through the opening, and a mechanism which controls the passage from one position of the point to the other.

In the preferred embodiments of the writing instrument according to the present invention, one or another of the following arrangements are additionally available:
the body includes a first tubular part and a second tubular part mounted pivotally relative to the first part, the first element of the mechanism being driven in rotation by the first part the second element of the mechanism being movable in translation relative to the second part, and the mechanism's guide being helical in order to transform the pivoting movement of one part of the body relative to the other into extension or retraction movement of the writing point;
the helical guide has a proximal end stop relative to the opening, a distal end stop, a first locking device arranged near the proximal end, and a second locking device arranged near the distal end, the locking thus being implemented solely with the help of the first and second elements of the mechanism;
a mobile member connected to the point forms the second element of the mechanism, the first par of the body forming the first element of the mechanism, and the second part having a housing cooperating with the mobile member and suited for guiding it in translation, with the objective of reducing the number of parts.

It should be noted that because of the restoring force and the elastic member with its position relative to the end stop, it is perfectly possible to not need a spring longitudinally stressing the mobile member. unlike most of the known mechanisms.

### BRIEF DESCRIPTION OF DRAWINGS

FIG. 1 is an exploded view of a writing instrument including a mechanism implemented according to the embodiments of the present invention;

FIG. 2 is a simplified cross-sectional view of the writing instrument shown in FIG. 1;

FIG. 3 is an enlarged partial view of an element of the instrument shown in FIG. 1.

In the various figures, the same references have been retained in order to denote identical or similar elements.

### DETAILED DESCRIPTION OF DRAWINGS

FIG. 1 an exploded view of a retractable ballpoint pen type writing instrument 1 is shown.

The pen has an outer body including a front point 2 provided with an opening, a first part 3 forming the front portion of the pen and a second part 4 forming the rear portion.

A cartridge 5 having a ballpoint 6 is mounted so as to slide through the opening of the point 2.

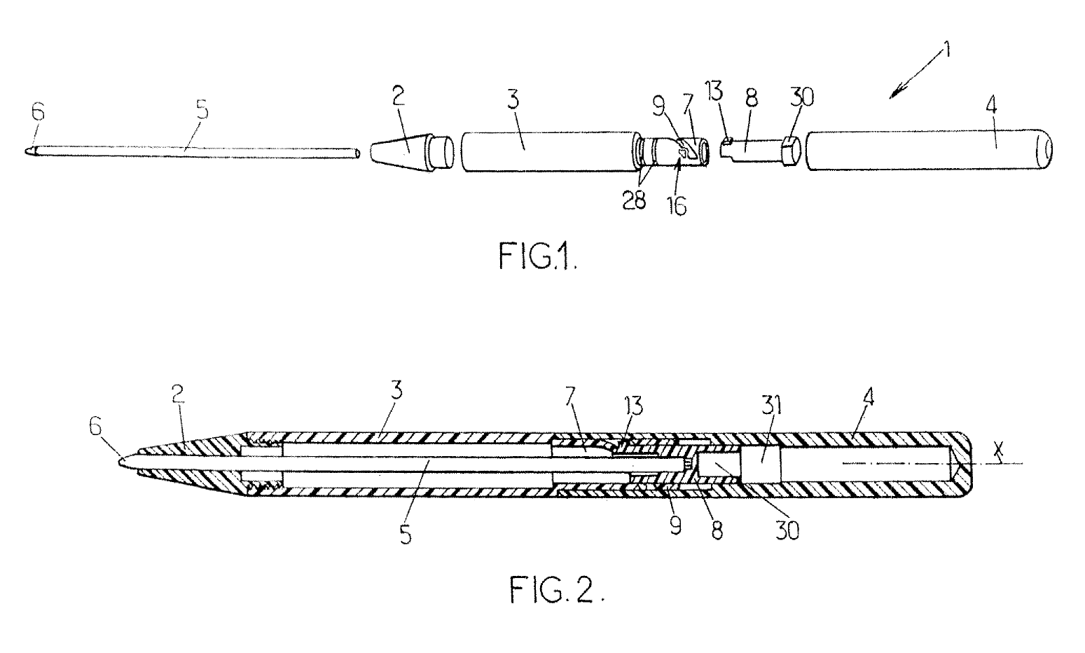

As can be seen better in FIG. 2, the cartridge 5 is connected to a mobile member 8 by the fitting of the rear end of the cartridge into a bore in this mobile member.

The mobile member 8 can move along the longitudinal axis X of the pen between a writing position for which the writing point 6 extends outside the body and a storage position for which the point 6 is arranged inside the body. The control of this movement will be explained in more detail below.

The first part 3 of the body has a portion 7 at the rear with a reduced diameter which goes inside the second tubular part 4 when the pen is assembled.

The rear portion 7 forms a first element of the mechanism making it possible to extend or retract the writing point 6. This first element 7 includes a guide 9 delimited laterally by a first edge 11 and a second edge 12 which extend parallel to each other along a helical line.

The mobile member 8 corresponds to a second element of the mechanism which includes a pin 13. The pin 13 extends in the guide 9 and can slide along the guide 9.

In the embodiment shown, the first element 7 is tubular and the guide 9 forms a helical slit which passes through this element. However, it could be a helical groove.

The mobile member 8 has a cylindrical outer face whose diameter is suitable for going into the first element 7, the pin 13 extending radially relative to this outer cylindrical face. It should be noted that the mobile member 8 has a notch at its front end which facilitates the insertion of the pin in the guide 9.

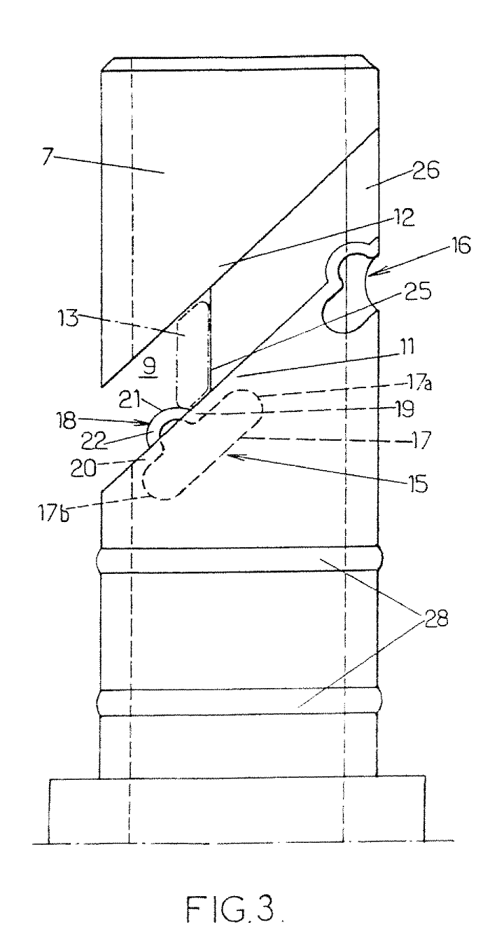

As can be better seen in FIG. 3, the first element 7 has first and second locking devices 15, 16.

The locking device 15 includes a recess 17 which extends into the first edge 11 of the guide between a first end 17a and a second end 17b. In the embodiment shown, the recess 17 has the shape of an oblong hole traversing the wall of the first element 7 but it could be a simple hollow notably in the case where the guide 9 is formed by a groove.

The locking device 15 additionally includes an elastic member 18 which extends across the recess 17. The elastic member includes a first base 19 integral with the first end 17a, a second base 20 integral with the second end 17b and a summit 21 made up by the base of a U-shaped intermediate portion 22, the ends of whose branches are integral with the first and second bases 19, 20.

The summit 21 is laid out in the guide 9 at a distance from the second edge 12 which must be less than the width of the pin, this length being measured along an axis largely perpendicular to the edges (11, 12).

Thus, when the pin 13 slides in the guide 9, it comes in contact with the intermediate portion 22 of the elastic member which creates a resistance to the movement of the pin. The user will then be able to increase the force exerted on a controlling member driving the second element 8 so that the pressure exerted by the pin on the intermediate portion 22 is greater than the elastic restoring force of the member 18. The elastic member 18 is then pushed back into the recess 17 whose dimensions must be suitable for allowing a withdrawing of the summit 21. Of course. the elastic member returns to its position after the passage of the pin.

The intermediate portion 22 of the elastic member thus forms a locking point along the guide 9, which requires a specified force in order to go beyond it. It should be noted that this force principally depends on the shape of the elastic member 18 and on the profile of the pin 13 but is not influenced by other parts of the pen, such as a spring which may, for example, be compressed to a greater or lesser extent.

In the embodiment shown, the first and second bases 19, 20 and the intermediate portion 22 form a bridge above the recess, but it is conceivable that the intermediate portion 22 only be connected to the first edge 11 by a single base, for example the first base 19, and that the intermediate portion 22 extend all the way to the area of the second end 17b.

However, the bridge-shaped structure makes it possible to more precisely control the force necessary for pushing the elastic member 18 back into the recess, and prevents the elastic member from getting in the way of the guide 9, which could prevent the crossing of the locking point.

It should be noted that the first and second bases 19, 20 extend in the extension of the first edge 11 so as to form a continuous surface on which the pin can slide smoothly.

The guide 9 is closed at its ends by stops, namely a proximal stop 25 situated longitudinally on the side of the writing point 6 and an opposing stop 26 referred to as distal stop.

As can be seen in FIG. 3 where the pin 13 is symbolically shown in dashed lines, the intermediate portion 22 of the elastic member 18 is located at a distance from the end stop 25 such that the elastic member 18 can be in contact with the pin 13 when it is pressing against the stop 25. Thus, a locked position is obtained in which the pin 13 of the second element is immobilized, without play, by the first element 7.

However, it is conceivable that this immobilization could be obtained by a contact point between the elastic member 18 and the pin 13, and a contact point between the mobile member 8 and a stop which makes up part of the second part 4 of the body.

The first base 19 extends in the extension of the edge 11 over a longer distance than the second base 20 such that the first base 19 has greater elasticity. This provision makes it easier to change over the position from the intermediate portion 22 to the first base 19, such that the force necessary to bring the pin 13 into the position shown in FIG. 3 is less that the force necessary to leave this position. In other words, it is easier to lock the mechanism than to unlock it, which increases the reliability of the locking without reducing the comfort of use. But it is possible to adopt an inverse arrangement for one or the other of the locking devices.

The second locking device 16 has an identical structure to that of the first device 15 and is laid out in an analogous manner relative to the far end stop 26. This second locking device will not be described in more detail. but it should be noted that it allows locking of the writing point 6 in a retracted position whereas the first locking device 15 locks the point in extended position.

The first element 7 of the mechanism including the first and second locking devices 15, 16 and the guide 9, together with the first part 3 of the body are formed as a single part. This part may be made of any known plastic having suitable elastic properties. In order to obtain mass production at a minimum cost, the part forming the first element of the mechanism and the first part of the body is made by injection of plastic in a mold.

The mechanism described above tends itself particularly well to the production of a writing instrument whose extension/retraction is controlled by pivoting a first part of the body relative to one or more other parts of the body.

For this purpose, in the embodiment shown, the second part 4 of the body is engaged on the rear portion 7 of the first part 3 so as to be able to pivot relative to this through an angular range of about 180°.

Peripheral ribs 28 formed on the rear portion 7 engage with corresponding grooves formed in the inner surface of the second part 4 so as to prevent any relative movement along the longitudinal axis X.

The mobile member 8 includes a rear end 30 of non cylindrical cross section, for example, including opposing flat surfaces. The rear part 4 includes a housing 31 extending along the longitudinal axis and whose cross section predominantly corresponds to the cross section of the rear end 30, such that it can slide into the rear part 4 along the longitudinal axis X.

To change from an extended position to a retracted position of the point 6, and inversely, the user creates a pivoting movement between the first part 3 and the second part 4 of the body, of about a half turn. The mobile member 8, which is rotated by the second part 4, performs a forward or backward movement because of the cooperation of the pin 13 with the guide 9. When the mechanism approaches the extended position or the retracted position, the user passes a stiff point, which indicates that the pen is locked in writing or storage position.

Once one or other of these positions is reached, the writings point is immobilized and only a torque exerted between the first and second parts 3, 4, sufficient to overcome the restoring force of the locking device 15, 16, makes it possible to leave the point's storage or extended position.

It should be noted that because of positive guiding of the mobile element 8 and elastic locking, it is not necessary to provide a spring which stresses the cartridge along a longitudinal direction.

Further, because the first element 7 of the mechanism is an integral part of the first part 3 of the body, the number of parts making up the pen is reduced. In the embodiment shown, these parts add up to five but it would be conceivable to make a pen solely of three parts by integrating the point 2 with the first part 3 and by integrally forming the mobile member 8 with the cartridge 5.

Consequently, the embodiment described above makes it possible to implement a particularly low cost writing instrument for which the number of assembly operations is limited.

But of course, the first and second elements 7, 8 could be distinct from the parts 3 and 4 forming the body, and could even be connected to it through the intermediary of additional parts such as sleeves.

For a person skilled in the art it will be clear that the mechanism including the mobile member 8 and the rear portion 7 provided with the guide 9 could be used in the field of writing instruments not only for extending and retracting a writing point, but also for controlling the movement of other members. For example, by the use of such a mechanism it is possible to control the movement of an eraser, a device for advancing leads or even the combined movement of a writing point and of a member for blocking the body's opening.

1-11. (canceled)

12. A mechanism for writing instruments comprising:
a first element including a guide extending between substantially parallel first and second edges;
a second element including a pin extending into the guide and movable along the guide, the pin having a given width in a transverse direction of the guide; and
at least one locking device for the pin,
wherein said at least one locking device includes a recess extending in the first edge between a first and a second end and, an elastic member which extends opposite the recess from at least one first base integral with the first end of the recess to a summit placed in the guide at a distance from the second edge, the distance being less than the width of the pin.

13. The mechanism according to claim 12, wherein the first base of the elastic member extends into the extension of the first edge.

14. The mechanism according to claim 13, wherein the elastic member has a second base integral with the second end of the recess.

15. The mechanism according to claim 12, wherein the elastic member includes a general U-shaped portion.

16. The mechanism according to claim 14, wherein the first base has a length substantially greater than the length of the second base.

17. The mechanism according to claim 12 wherein the guide has at least one end stop extending between the first and second edges, the locking device being arranged at a distance from the stop which is suitable for the elastic member to be in contact with the pin when it is pressed against the end stop.

18. The mechanism according to claim 12, wherein the first element and the locking device comprise a single member.

19. A writing instrument comprising:
a tubular body having a front end provided with an opening;
a writing point capable of moving between a storage position in which the point is arranged inside said tubular body and a writing position in which the point passes through the opening; and
a mechanism according to claim 12, which controls the movement of said writing point from the storage position to the writing position. and from the writing position to the storage position.

20. The writing instrument according to claim 19, wherein said body includes a first tubular part and a second tubular part mounted pivotally relative to the first part, said first element of the mechanism being driven in rotation by the first tubular part, said second element of the mechanism being movable in translation relative to the second tubular part, wherein said guide includes a helical shape.

21. The writing instrument according to claim 20, wherein said guide includes a proximal end stop relative to the opening, a distal end stop, a first locking device arranged proximal the rear end, and a second locking device arranged near the distal end.

22. The writing instrument according to claim 19, wherein a mobile member connected to the point forms said second element, the first pan of said body forms said first element, and the second part of said body includes a housing capable of cooperating with the mobile member and suited for guiding the mobile member in translation.

23. A mechanism for writing instruments comprising:
a first element including a guide extending between substantially parallel first and second edges;
a second element including a pin extending into the guide and movable along the guide, the pin having a given width in a transverse direction of the guide; and
at least one locking device for the pin,
wherein said at least one locking device includes a recess extending in the first edge between a first and a second end, and an elastic member which extends opposite the recess from at least one first base integral with the first end of the recess to a summit placed in the guide at a distance from the second edge, the distance being less than the width of the pin, and
wherein the first base of the elastic member extends into the extension of the first edge.

24. A mechanism for writing instruments comprising:
a first element including a guide extending between substantially parallel first and second edges;
a second element including a pin extending into the guide and movable along the guide, the pin having a given width in a transverse direction of the guide; and
at least one locking device for the pin.
wherein said at least one locking device includes a recess extending in the first edge between a first and a second end, and an elastic member which extends opposite the recess from at least one first base integral with the first end of the recess to a summit placed in the guide at a distance from the second edge, the distance being less than the width of the pin,
wherein the first base of the elastic member extends into the extension of the first edge, and
wherein the elastic member has a second base integral with the second end of the recess.
